(19) United States
(12) Patent Application Publication
(10) Pub. No.: US 2024/0250416 A1
(43) Pub. Date: Jul. 25, 2024

(54) LOW DIELECTRIC, LOW LOSS RADOMES, MATERIALS AND METHODS FOR MAKING LOW DIELECTRIC, LOW LOSS RADOMES

(71) Applicant: Laird Technologies, Inc., Chesterfield, MO (US)

(72) Inventors: Douglas S. MCBAIN, Wadsworth, OH (US); Nathan Alan GREENE, Macedonia, OH (US)

(21) Appl. No.: 18/603,420

(22) Filed: Mar. 13, 2024

Related U.S. Application Data
(63) Continuation of application No. PCT/US22/43973, filed on Sep. 19, 2022.
(63) Continuation-in-part of application No. 18/209,399, filed on Jun. 13, 2023.
(63) Continuation-in-part of application No. 18/527,949, filed on Dec. 4, 2023.
Application No. 18/209,399 is a continuation of application No. PCT/US21/54705, filed on Oct. 13, 2021.
Application No. 18/209,399 is a continuation-in-part of application No. 17/490,831, filed on Sep. 30, 2021, now Pat. No. 11,848,491.
Application No. 18/527,949 is a continuation of application No. 17/490,831, filed on Sep. 30, 2021, now Pat. No. 11,848,491.
Application No. 17/490,831 is a continuation of application No. PCT/US20/26098, filed on Apr. 1, 2020.
(60) Provisional application No. 63/249,846, filed on Sep. 29, 2021.
(60) Provisional application No. 63/125,199, filed on Dec. 14, 2020.
(60) Provisional application No. 62/828,922, filed on Apr. 3, 2019.
(60) Provisional application No. 62/845,111, filed on May 8, 2019.

(51) Int. Cl. H01Q 1/42; B32B 3/12; B32B 5/02; B32B 5/18; B32B 5/24; B32B 7/025; B32B 27/12

(52) U.S. Cl. CPC H01Q 1/422; B32B 3/12; B32B 5/024; B32B 5/18; B32B 5/245; B32B 7/025; B32B 27/12; B32B 2250/03; B32B 2250/40; B32B 2260/021; B32B 2260/046; B32B 2262/0253; B32B 2262/0269; B32B 2264/107; B32B 2307/204; B32B 2307/3065; B32B 2307/54; B32B 2307/558; B32B 2307/706; B32B 2307/712

(57) ABSTRACT

Exemplary embodiments are disclosed of low dielectric, low loss radomes. Also disclosed are materials and methods for making low dielectric, low loss radomes.

### CROSS-REFERENCE TO RELATED APPLICATIONS

This application is a continuation of PCT International Patent Application No. PCT/US2022/043973 filed Sep. 19, 2022 (published as WO 2023/055597 on Apr. 6, 2023), which, in, turn, claims priority to and the benefit of U.S. Provisional Patent Application No. 63/249,846 filed Sep. 29, 2021.

This application is also a continuation-in-part of U.S. patent application Ser. No. 18/209,399 filed Jun. 13, 2023 (published as US 2023/0327332 on Oct. 12, 2023) and a continuation-in-part of U.S. patent application Ser. No. 18/527,949 filed Dec. 4, 2023.

U.S. patent application Ser. No. 18/209,399 is a continuation of PCT International Patent Application No. PCT/US2021/054705 filed Oct. 13, 2021 (published as WO2022/132297 on Jun. 23, 2022), which, in turn, claims the benefit of and priority to U.S. Provisional Patent Application No. 63/125,199 filed Dec. 14, 2020.

U.S. patent application Ser. No. 18/209,399 is also a continuation-in-part of U.S. patent application Ser. No. 17/490,831 filed Sep. 30, 2021 (published as US2022/0029282 on Jan. 27, 2022 and issued as U.S. Pat. No. 11,848,491 on Dec. 19, 2023).

U.S. patent application Ser. No. 18/527,949 is a continuation of U.S. patent application Ser. No. 17/490,831 filed Sep. 30, 2021 (published as US2022/0029282 on Jan. 27, 2022 and issued as U.S. Pat. No. 11,848,491 on Dec. 19, 2023).

U.S. patent application Ser. No. 17/490,831 is a continuation of PCT International Patent Application No. PCT/US2020/026098 filed Apr. 1, 2020 (published as WO2020/205923 on Oct. 8, 2020). PCT International Application No. PCT/US2020/026098 claims the benefit of and priority to U.S. Provisional Patent Application No. 62/828,922 filed Apr. 3, 2019 and U.S. Provisional Patent Application No. 62/845,111 filed May 8, 2019.

The entire disclosure of the above applications are incorporated herein by reference.

### FIELD

The present disclosure generally relates to low dielectric, low loss radomes, materials and methods for making low dielectric, low loss radomes.

### BACKGROUND

This section provides background information related to the present disclosure which is not necessarily prior art.

A radome is an electromagnetically transparent environmental protection enclosure for an antenna. A radome design typically must satisfy structural requirements for an outdoor environment as well as minimizing electromagnetic energy loss.

### DRAWINGS

The drawings described herein are for illustrative purposes only of selected embodiments and not all possible implementations, and are not intended to limit the scope of the present disclosure.

FIG. 1 is a line graph of dielectric constant versus frequency in gigahertz (GHz) for an injection molded thermoplastic with microspheres and an injection molded foamed thermoplastic for a radome according to exemplary embodiments of the present disclosure. As shown by FIG. 1, the injection molded foamed thermoplastic has a dielectric constant less than 2.25 for the frequency range from 18 GHz to 40 GHz.

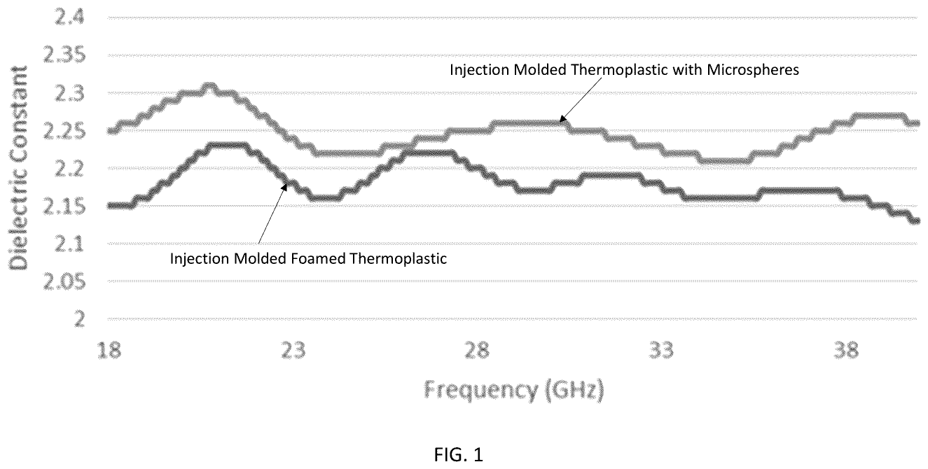

FIG. 2 is a line graph of dielectric constant versus frequency in gigahertz (GHz) for an injection molded foamed polyolefin thermoplastic according to exemplary embodiments of the present disclosure. As shown by FIG. 2, the injection molded foamed polyolefin thermoplastic has a dielectric constant less than 2 for the frequency range from 18 GHz to 40 GHz.

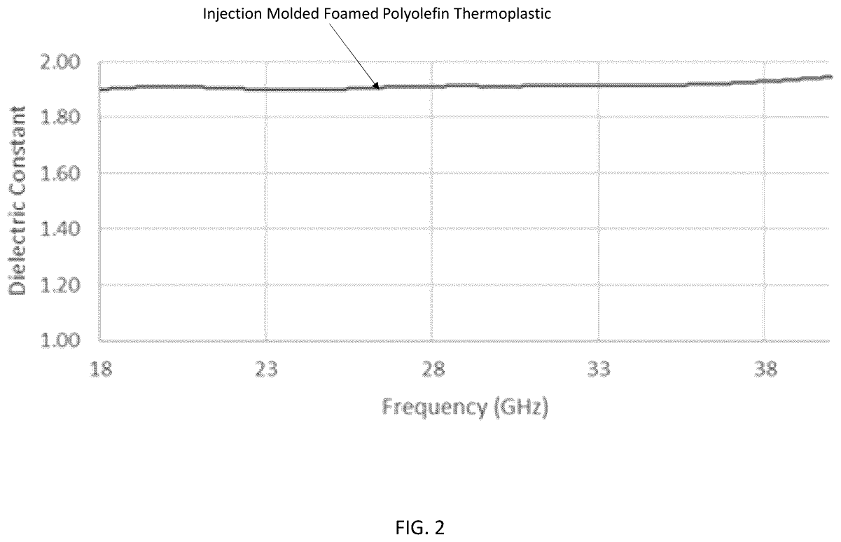

FIG. 3 show samples of a material comprising glass microspheres within a resin blend of polypropylene and cyclic olefin copolymer, which material may be used for radomes according to exemplary embodiments of the present disclosure.

FIG. 4 show samples of a material comprising a foamed resin bend of polypropylene and cyclic olefin copolymer, which material may be used for radomes according to exemplary embodiments of the present disclosure.

### DETAILED DESCRIPTION

Example embodiments will now be described more fully with reference to the accompanying drawings.

Conventional radomes have been made from composite materials that are able to satisfy structural requirements for outdoor use. But as recognized herein, conventional radome composite materials tend to have a rather high dielectric constant (e.g., a dielectric constant of 2.8 or higher, etc.) and dielectric loss tangent especially at high frequencies.

Accordingly, disclosed herein are exemplary embodiments of materials for low dielectric, low loss radomes configured to have an overall low dielectric constant and an overall low loss tangent or dissipation factor (Df) at relatively high frequencies. For example, exemplary embodiments of radomes made from materials disclosed herein are configured to have an overall low dielectric constant and an overall low loss tangent or dissipation factor (Df) at millimeter wave frequencies and/or relatively high frequencies (e.g., from about 20 Gigahertz (GHz) to 90 GHz, from about 20 GHz to about 50 GHz, from about 18 GHz to about 40 GHz, etc.).

In exemplary embodiments, a radome made from a material disclosed herein may be configured to have a dielectric constant of about 2.1 or less at frequencies from about 20 GHz to about 90 GHz and/or from about 20 GHz to about 50 GHz and/or from about 18 GHz to about 40 GHz. For example, the radome may be configured to have an average dielectric constant of about 1.93 or less (e.g., about 1.923 or less, about 1.906 or less, etc.) at frequencies from about 18 GHz to about 40 GHz. Or, for example, the radome may be configured to have an average dielectric constant of about 2.083 or less at frequencies from about 18 GHz to about 40 GHz.

In exemplary embodiments, a material for a low dielectric, low loss radome comprises a foamed thermoplastic. The foamed thermoplastic has a dielectric constant less than 2.3 at frequencies up to 90 gigahertz. The foamed thermoplastic has a plurality of closed pores including gas entrapped within at least some of the closed pores. The foamed thermoplastic may also include one or more open pores in addition to the closed pores having the gas entrapped within at least some of the closed pores.

In exemplary embodiments, the gas entrapped within at least some (e.g., all, less than all, a majority, etc.) of the closed pores of the foamed thermoplastic comprises nitrogen or carbon dioxide. The gas entrapped within at least some of the closed pores of the foamed thermoplastic provides a weight reduction within a range from about 10% to about 25% as the gas has a density less than the density of the unfoamed thermoplastic. For example, the gas entrapped within at least some of the closed pores of the foamed thermoplastic may provide a weight reduction within a range from about 15% to about 20%. Also, the gas entrapped within at least some of the closed pores of the foamed thermoplastic provides a dielectric constant reduction of at least about 10% as the gas has a dielectric constant lower than the dielectric constant of the unfoamed thermoplastic.

In exemplary embodiments, the foamed thermoplastic has a lower dielectric constant due to the gas entrapped within at least some of the closed pores. The foamed thermoplastic has a pore density within a range from about 20% to about 50%. The foamed thermoplastic has a closed porosity.

In exemplary embodiments, the foamed thermoplastic comprises polyolefin, such as polypropylene, cyclic olefin copolymer, polyethylene (e.g., low-density polyethylene (LDPE), high-density polyethylene (HDPE), ultra-high-density polyethylene (UHDPE), etc.), other polymers in the polyolefin family, and combinations or blends thereof (e.g., blend of polypropylene and cyclic olefin copolymer, etc.), etc.

In exemplary embodiments, the foamed thermoplastic comprises a blend of polypropylene and cyclic olefin copolymer. The blend of the polypropylene and the cyclic olefin copolymer may have an average dielectric constant of about 2.2 for frequencies from 18 gigahertz to 40 gigahertz. The gas entrapped within at least some of the closed pores may reduce dielectric constant such that the foamed thermoplastic has an average dielectric constant less than 2 for frequencies from 18 gigahertz to 40 gigahertz. The blend of the polypropylene and the cyclic olefin copolymer may include at least about 5 weight percentage to about 50 weight percentage of the cyclic olefin copolymer (e.g., 5 weight percentage, 20 weight percentage, 50 weight percentage, etc.). For example, the blend of the polypropylene and the cyclic olefin copolymer may include about 80 weight percentage of the polypropylene and about 20 weight percentage of the cyclic olefin copolymer.

In exemplary embodiments, a material for a low dielectric, low loss radome comprises a foamed resin. The foamed resin comprises polypropylene and/or polyolefin. The foamed resin has a plurality of closed pores including gas entrapped within at least some (e.g., all, less than all, a majority of, etc.) of the closed pores. The foamed resin may also include one or more open pores in addition to the plurality of closed pores having the gas entrapped within at least some of the closed pores.

In exemplary embodiments, the gas entrapped within at least some of the closed pores of the foamed resin comprises nitrogen or carbon dioxide. The gas entrapped within at least some of the closed pores of the foamed resin provides a weight reduction within a range from about 10% to about 25% as the gas has a density less than the density of the unfoamed resin. For example, the gas entrapped within at least some of the closed pores of the foamed resin may provide a weight reduction within a range from about 15% to about 20%. Also, the gas entrapped within at least some of the closed pores of the foamed resin provides a dielectric constant reduction of at least about 10% as the gas has a dielectric constant lower than the dielectric constant of the unfoamed resin.

In exemplary embodiments, the foamed resin includes the polyolefin, which comprises cyclic olefin copolymer. For example, the foamed resin may comprise a blend of the polypropylene and the cyclic olefin copolymer. The blend of the polypropylene and the cyclic olefin copolymer may have an average dielectric constant of about 2.2 for frequencies from 18 gigahertz to 40 gigahertz. The gas entrapped within at least some of the closed pores reduces dielectric constant such that the foamed resin has an average dielectric constant less than 2 for frequencies from 18 gigahertz to 40 gigahertz. The blend of the polypropylene and the cyclic olefin copolymer may include at least about 5 weight percentage to about 50 weight percentage of the cyclic olefin copolymer (e.g., 5 weight percentage, 20 weight percentage, 50 weight percentage, etc.). For example, the blend of the polypropylene and the cyclic olefin copolymer may include about 80 weight percentage of the polypropylene and about 20 weight percentage of the cyclic olefin copolymer.

In exemplary embodiments, the foamed resin has a lower dielectric constant due to the gas entrapped within at least some of the closed pores. The foamed resin has a pore density within a range from about 20% to about 50%. The foamed resin has a closed porosity.

In exemplary embodiments, a material for a low dielectric, low loss radome comprises microspheres within a resin matrix. The resin matrix comprises cyclic olefin copolymer.

In exemplary embodiments, the resin matrix comprises a blend of polypropylene and the cyclic olefin copolymer. And the microspheres are within the blend of the polypropylene and the cyclic olefin copolymer.

In exemplary embodiments, the microspheres comprise glass microspheres within the blend of the polypropylene and the cyclic olefin copolymer such that material includes about 50 volume percent of the glass microspheres. The material has a dielectric constant of less than 2.1 for frequencies from 18 gigahertz to 40 gigahertz. The blend of the polypropylene and the cyclic olefin copolymer may include at least about 5 weight percentage to about 50 weight percentage of the cyclic olefin copolymer (e.g., 5 weight percentage, 20 weight percentage, 50 weight percentage, etc.). For example, the blend of the polypropylene and the cyclic olefin copolymer may include about 80 weight percentage of the polypropylene and about 20 weight percentage of the cyclic olefin copolymer.

In exemplary embodiments, the microspheres comprise hollow glass, plastic, and/or ceramic microspheres, microballoons, or bubbles within the resin matrix. For example, the microspheres may comprise glass microspheres within the resin matrix such that the material includes about 50 volume percent of the glass microspheres.

In exemplary embodiments, the material includes about 40 volume percent to about 60 volume percent of the resin matrix (e.g., about 50 volume percent of the resin matrix, etc.) and about 40 volume percent to about 60 volume percent of the microspheres (e.g., about 50 volume percent of the microspheres, etc.).

In exemplary embodiments, a radome is made from the material that comprises the microspheres within the resin matrix comprising cyclic olefin copolymer. The microspheres are integrated into the resin matrix such that: the radome does not have outer and inner skin layers disposed on opposite sides of a core that define a three-layer A-sandwich structure; and/or the radome has a homogenous and/or unitary structure that is thermoformable prior to cure and/or that has a substantially uniform low dielectric constant less than 2.1 through a thickness of the radome.

Exemplary methods of making low dielectric, low loss radomes are also disclosed herein. An exemplary method comprises injecting a fluid into a thermoplastic to thereby provide a foamed thermoplastic having a dielectric constant less than 2.3 at frequencies up to 90 gigahertz; and injection molding the foamed thermoplastic to thereby provide at least a portion of the radome that is injection molded from the foamed thermoplastic.

In exemplary methods, injecting a fluid into a thermoplastic comprises injecting a supercritical fluid into the thermoplastic. The injected supercritical fluid transitions to a gas phase, which gas is entrapped within at least some (e.g., all, less than all, a majority of, etc.) of the closed pores of the foamed thermoplastic. For example, the method may include a plasticization process during which supercritical carbon dioxide or nitrogen fluid is injected into the thermoplastic. The injected supercritical fluid is mixed and/or disbursed (e.g., homogeneously, etc.) into the thermoplastic to thereby create a single phase injection moldable solution comprised of the supercritical fluid and the thermoplastic. The injection moldable solution may then be introduced or injected into a mold cavity for the radome. And the filling of the mold cavity may occur at relatively low pressure. Within the mold cavity, cells will start to nucleate after exposure to the lower pressure within the mold cavity, and molecular dispersion of the supercritical fluid will provide a homogeneous closed cell structure with a solid skin layer. After the mold cavity is filled, controlled cell growth may provide a relatively uniform and locally applied pack pressure through the mold cavity.

In exemplary methods, the fluid comprises nitrogen or carbon dioxide. The thermoplastic comprises polyolefin, such as polypropylene, cyclic olefin copolymer, polyethylene (e.g., low-density polyethylene (LDPE), high-density polyethylene (HDPE), ultra-high-density polyethylene (UHDPE), etc.), other polymers in the polyolefin family, and combinations or blends thereof (e.g., blend of polypropylene and cyclic olefin copolymer, etc.), etc.

In exemplary methods, the gas entrapped within at least some of the closed pores of the foamed thermoplastic provides a weight reduction within a range from about 10% to about 25% as the gas has a density less than the density of the unfoamed thermoplastic. For example, the gas entrapped within at least some of the closed pores of the foamed thermoplastic may provide a weight reduction within a range from about 15% to about 20%. Also, the gas entrapped within at least some of the closed pores of the foamed thermoplastic provides a dielectric constant reduction of at least about 10% as the gas has a dielectric constant lower than the dielectric constant of the unfoamed thermoplastic. The gas entrapped within at least some of the closed pores of the foamed thermoplastic reduces dielectric constant such that the foamed thermoplastic has an average dielectric constant less than 2 for frequencies from 18 gigahertz to 40 gigahertz.

In exemplary methods, the thermoplastic comprises a blend of polypropylene and cyclic olefin copolymer. The blend of the polypropylene and the cyclic olefin copolymer may include at least about 5 weight percentage to about 50 weight percentage of the cyclic olefin copolymer (e.g., 5 weight percentage, 20 weight percentage, 50 weight percentage, etc.). For example, the blend of the polypropylene and the cyclic olefin copolymer includes about 80 weight percentage of the polypropylene and about 20 weight percentage of the cyclic olefin copolymer. Also, the blend of the polypropylene and the cyclic olefin copolymer has an average dielectric constant of about 2.2 for frequencies from 18 gigahertz to 40 gigahertz.

In exemplary methods, the foamed thermoplastic includes fibers within the foamed thermoplastic that comprise polytetrafluoroethylene (PTFE). In such exemplary embodiments, the foamed thermoplastic may include about 0.1 weight percentage to about 5 weight percentage of the PTFE fibers. For example, the foamed thermoplastic may include about 0.2 weight percentage to about 3 weight percentage of the PTFE fibers. Preferably, the foamed thermoplastic includes about 0.3 weight percentage to about 2 weight percentage to about 3 weight percentage of the PTFE fibers.

Exemplary methods includes a microcellular foam injection molding process during which a supercritical fluid is injected into the thermoplastic and the foamed thermoplastic is injection molded. In such exemplary methods, the supercritical fluid may comprise carbon dioxide or nitrogen that is used as a physical blowing agent. The foamed thermoplastic may comprise a microcellular polymer foam, e.g., having microcellular gas bubbles from 1 micron to 100 microns in size (e.g., less than 50 microns in size, etc.) and a cell density greater than 10⁹ cells/cm³, etc.

In exemplary methods, chemical foaming agents are not used such that the foamed thermoplastic does not have any chemical residue from a chemical foaming agent within the foamed thermoplastic.

In exemplary methods, the foamed thermoplastic comprises a blend of polypropylene and cyclic olefin copolymer. The blend of the polypropylene and the cyclic olefin copolymer may include at least about 5 weight percentage to about 50 weight percentage of the cyclic olefin copolymer (e.g., 5 weight percentage, 20 weight percentage, 50 weight percentage, etc.). For example, the blend of the polypropylene and the cyclic olefin copolymer may include about 80 weight percentage of the polypropylene and about 20 weight percentage of the cyclic olefin copolymer.

In exemplary embodiments, the material includes one or more impact modifiers within the material. The one or more impact modifiers within the material may comprise one or more of acrylic styrene acrylonitrile, methacrylate butadiene styrene terpolymer, acrylate polymethacrylate copolymer, chlorinated polyethylene, ethylene vinyl acetate copolymer, acrylonitrile butadiene styrene terpolymer, and/or polyacrylate.

In exemplary embodiments, the material includes fibers (e.g., aramid, polytetrafluoroethylene (PTFE), etc.) within the material. For example, the fibers may comprise one or more of flame-resistant meta-aramid material, polytetrafluoroethylene (PTFE), other suitable fiber materials, combinations thereof, etc. In exemplary embodiments, the material may comprise fibrillated cyclic olefin copolymer (COC).

In exemplary embodiments, the material includes fibers within the material wherein the fibers comprise polytetrafluoroethylene (PTFE). In such exemplary embodiments, the material may include about 0.1 weight percentage to about 5 weight percentage of the PTFE fibers. For example, the material may include about 0.2 weight percentage to about 3 weight percentage of the PTFE fibers. Preferably, the material includes about 0.3 weight percentage to about 2 weight percentage to about 3 weight percentage of the PTFE fibers.

In exemplary embodiments, the material further comprises flame retardant within the material.

In exemplary embodiments, the material has a dielectric constant less than 2.1 at frequencies up to 90 gigahertz. And the material has a UL94 flame rating of V0.

In exemplary embodiments, the material is compliant with ROHS Directive 2011/65/EU and (EU) 2015/863; and/or the material is compliant with REACH as containing less than 0.1% by weight of substances on the REACH/SVHC candidate list (Jun. 25, 2020).

In exemplary embodiments, the material includes no more than a regulated threshold of 0.01% by weight of Cadmium, no more than a regulated threshold of 0.1% by weight of Lead, no more than a regulated threshold of 0.1% by weight of Mercury, no more than a regulated threshold of 0.1% by weight of Hexavalent chromium, no more than a regulated threshold of 0.1% by weight of Flame retardants PBB and PBDE including pentabromodiphenyl ether (CAS-No. 32534-81-9), octabromodiphenyl ether (CAS-No. 32536-52-0) and decabromodiphenyl ether (CAS-No. 1163-19-5), no more than a regulated threshold of 0.1% by weight of Bis(2-ethylhexyl) phthalate (DEHP) (CAS-No. 117-81-7), no more than a regulated threshold of 0.1% by weight of Butyl benzyl phthalate (BBP) (CAS-No. 85-68-7), no more than a regulated threshold of 0.1% by weight of Dibutyl phthalate (DBP) (CAS-No. 84-74-2), and no more than a regulated threshold of 0.1% by weight Diisobutyl phthalate (DIBP) (CAS-No. 84-69-5).

In exemplary embodiments, the material is configured to have: a dielectric constant less than 1.9 for frequencies up to 90 gigahertz; and a loss tangent less than 0.01 for frequencies up to 90 gigahertz.

In exemplary embodiments, the material is injection moldable.

In exemplary embodiments, the material comprises thermoplastic injection moldable pellets.

In exemplary embodiments, a radome comprises at least a portion made from a material disclosed herein. For example, the entire radome may be injection molded from the material. The radome may have a dielectric constant less than 2.1 for frequencies up to 90 gigahertz. The radome may have a loss tangent less than 0.01 at frequencies up to 90 GHz. The radome may have a UL94 flame rating of V0. The radome may be configured for use with a mmWave 5G antenna, a 5G repeater, and/or a 5G to WiFi6 router.

In exemplary embodiments, a device comprises the radome having the at least a portion made from a material disclosed herein. The device may be a mmWave 5G antenna, a 5G repeater, and/or a 5G to WiFi6 router.

In exemplary embodiments, a method of making a low dielectric, low loss radome, comprises injection molding a material disclosed herein to thereby provide at least a portion of the radome that is injection molded from the material.

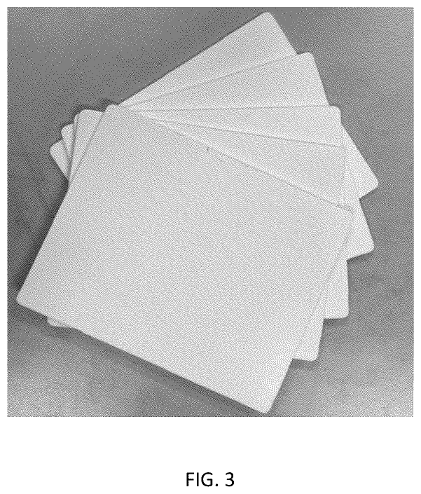

For purpose of illustration only, data will now be provided for different material samples according to exemplary embodiments. For a first series of testing, the material samples (FIG. 3) comprised glass microspheres within a resin blend of polypropylene (PP) and cyclic olefin copolymer (COC). The material samples included about 50 volume percent of the glass microspheres and about 50 volume percent of the PP/COC blend. The PP/COC blend included about 80 weight percentage of the polypropylene and about 20 weight percentage of the cyclic olefin copolymer. The material samples had a thickness of about 2.04 millimeters.

The testing of the material samples revealed an SPDR (Split Post Dielectric Resonator) average dielectric constant of 2.059 and an average dielectric constant of 2.083, 2.078, 2.023, and 2.022 for frequencies from 18 GHz to 40 GHz. With further regard to SPDR, Table 1 below provides additional information on the dielectric constant and tangent loss.

TABLE 1

| | | | mm | | |
|---|---|---|---|---|---|
| | HZ | Q | Thickness | dK | Tangent Loss |
| Air | 1201.78 | 15465 | — | | |
| 1 | 1198.94 | 11964 | 2.04 | 2.055 | 2.07E−03 |
| 2 | 1198.94 | 12053 | 2.04 | 2.057 | 2.00E−03 |
| 3 | 1198.93 | 11897 | 2.04 | 2.059 | 2.11E−03 |
| 4 | 1198.93 | 11999 | 2.04 | 2.060 | 2.04E−03 |
| 5 | 1198.95 | 11936 | 2.04 | 2.054 | 2.09E−03 |
| 6 | 1198.92 | 11985 | 2.04 | 2.062 | 2.04E−03 |
| 7 | 1198.93 | 11908 | 2.04 | 2.059 | 2.11E−03 |
| 8 | 1198.93 | 12037 | 2.04 | 2.060 | 2.01E−03 |
| 9 | 1198.93 | 12028 | 2.04 | 2.058 | 2.02E−03 |
| 10 | 1198.91 | 11854 | 2.04 | 2.068 | 2.14E−03 |

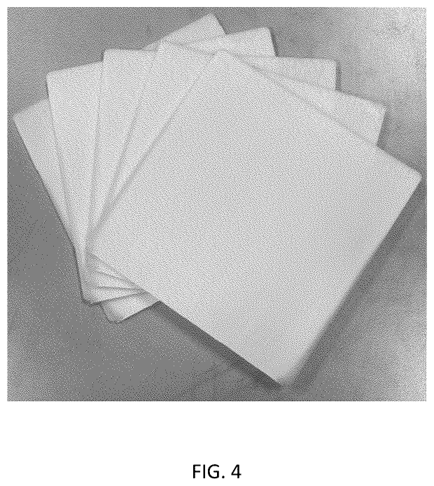

For a second series of testing, material samples (FIG. 4) were made via a microcellular foam injection molding process during which a supercritical fluid of carbon or nitrogen was injected into resin blend of polypropylene (PP) and cyclic olefin copolymer (COC), to thereby provide a microcellular foam comprising the PP/COC blend. The PP/COC blend included about 80 weight percentage of the polypropylene and about 20 weight percentage of the cyclic olefin copolymer. The microcellular foam material samples had a thickness of about 1.91 millimeters.

The testing of the microcellular foam material samples revealed an SPDR average dielectric constant of 1.98 and an average dielectric constant of 1.9143 for frequencies from 18 GHz to 40 GHz. By comparison, the unfoamed PP/COC blend had a higher a SPDR average dielectric constant of 2.27 and a higher average dielectric constant of 2.22 for frequencies from 18 GHz to 40 GHz. With further regard to SPDR, Table 2 below provides additional information on the dielectric constant and tangent loss for the microcellular foam material samples.

TABLE 2

| | | | Middle | | |
|---|---|---|---|---|---|
| | HZ | Q | Thickness | dk | Loss Tangent |
| AIR | 1201.84 | 15483 | | | |
| 1 | 1199.34 | 15115 | 1.91 | 1.9906 | 0.00020626 |
| 2 | 1199.33 | 14971 | 1.91 | 1.99176 | 0.00028197 |
| 3 | 1199.34 | 15184 | 1.91 | 1.99016 | 0.00017045 |
| 4 | 1199,42 | 15015 | 1.91 | 1.95692 | 0.00026325 |
| 5 | 1199,34 | 15233 | 1.91 | 1.98939 | 0.00014524 |
| 6 | 1199.33 | 14903 | 1.91 | 1.99214 | 0.00031822 |
| 7 | 1199.33 | 14898 | 1.91 | 1.99214 | 0.0003209 |
| 8 | 1199.41 | 14950 | 1.91 | 1.96248 | 0.00029752 |

Table 3 provides additional information about (1) polypropylene (PP), (2) cyclic olefin copolymer (COC), (3) a PP/COC blend including about 80 weight percentage of the polypropylene and about 20 weight percentage of the cyclic olefin copolymer, and (4) the PP/COC blend with about 50 volume percent of glass microspheres within the PP/COC blend. For the dielectric constant, loss tangent, and drop-ball impact tests, relatively flat sheets of the material test samples (e.g., FIG. 3) were evaluated. For the additional physical data provided in the Table 3 below, sample materials were injected molded into standardized tensile bars and standardized flexural bars.

TABLE 3

| | | PP | COC | PP/COC Unfilled | PP/COC 50% v Glass Spheres |
|---|---|---|---|---|---|
| Tensile Modulus | MPa | 1252.33 | 2900 | 1587.78 | 3103.5 |
| Tensile Stress @ Break | MPa | 16.01 | 63 | 19.44 | 9.75 |
| Tensile Elongation @ Break | % | 192.16 | 2.7 | 6.41 | 0.569 |
| Flexural Modulus | MPa | 951 | 3144 | 1205.5 | 2003.01 |
| Ultimate Flexural Strength | MPa | 28.62 | 101.4 | 33.25 | 18.48 |
| Flexural Elongation @ Break | % | *5 | — | *5 | 1.05 |
| Un-Notched Izod Impact | ft-lb/in | 20.1 (NB) | 0.36** | 9.35 | 0.735 |
| Un-Notched Izod Impact (−40 C.) | ft-lb/in | 11.3 | — | 4.45 | 0.718 |
| Drop-Ball Impact | kg*m/s\hat{ }2 | — | — | — | 5.243 @ 2 mm Thickness |

*Sample measured at 5% elongation and did not break
**Notched Izod

Generally, the testing shows that PP/COC blend with the glass microspheres had a lower dielectric constant, lower insertion loss, and lower weight than the PP/COC blend alone. And the PP/COC blend with the glass microspheres had sufficient flexibility and strength. The testing also showed that the foamed PP/COC resin blend had a lower dielectric constant, lower insertion loss, and lower weight than the PP/COC blend with the glass microspheres. And the foamed PP/COC resin blend had sufficient flexibility and strength.

By way of example, Tables 1, 2, and 3 above include example properties that the radome materials (e.g., microcellular polymer foam, foamed PP/COC resin blend, foamed thermoplastic, PP/COC blend including microspheres, etc.) may have in exemplary embodiments. In other exemplary embodiments, the materials for radomes and radomes made therefrom may be configured differently, e.g., have one or more different properties that what is shown in Tables 1, 2, and 3 above, etc.

In exemplary embodiments, a radome may be configured to have a low dielectric constant, low loss, and low weight. The radome may be configured or suitable for outdoor applications with strong impact resistance, high tensile strength for structural requirements, and rigid. The radome has an ultra-low dielectric constant outer surface to enhance antenna signal performance and provide better impact resistance. The low dielectric constant outer incident surface allows for less signal strength loss as the signal enters the material compared to an overall low dielectric constant (dK) material with a higher dielectric constant outer surface. The radome may be used to provide environmental protection of antennas with very low signal interference. The radome may be configured (e.g., optimized, etc.) for performance in 5G antenna applications. The radome may have a low dielectric surface increasing radome performance with increased signal pass through strength. The radome may be an environmentally friendly solution that meets including RoHS and REACH. The radome may be thermoplastic and capable of being thermoformed into complex curves to fit device application and aesthetic needs. The radome may be painted to meet customer required color needs. The radome may configured for use with 5G indoor antennas, routers (e.g., 5G to WiFi6 routers, etc.), repeaters (e.g., indoor 5G repeaters, etc.), etc. The radome may be configured for use as an in-building wireless radome, 5G small cell indoor radome, etc.

In exemplary embodiments, the radome may comprise a homogeneous dielectric constant material providing a uniform dielectric constant through its width. This allows for a low dielectric constant at the initial incident surface for increased signal pass through strength and better signal performance at off angles. The radome's homogeneous structure increases radome performance with increased signal pass through strength and better signal performance at higher incidence angles.

In exemplary embodiments, a material for a radome may be made by a method or process (e.g., calendering, etc.) during which fibers/fabric are embedded, integrated, incorporated, comingled, and/or mixed within resin matrix comprising cyclic olefin copolymer (COC) having microspheres (e.g., hollow glass microspheres, hollow plastic microspheres, hollow ceramic microspheres, microballoons, or bubbles, etc.). The embedded fibers/fabric may provide reinforcement and strength to the material for carrying loads, whereas the low dielectric microspheres preferably help to reduce the overall dielectric constant. The embedded fibers/fabric may comprise NOMEX flame-resistant meta-aramid material, DACRON open weave polymeric fabric, other open weave polymeric fabric, other prepreg or reinforcement, etc. The radome material may be drawn or otherwise shaped in three dimensions. In such exemplary embodiments, the radome has a single unitary structure, e.g., does not have a 3-layer laminated A-sandwich structure, does not have separate outer and inner skin layers, etc.

In exemplary embodiments, the radome construction is anisotropic and/or configured to provide a performance enhancement by minimizing or reducing cross polarization differences between horizontal and vertical polarizations. The radome may be configured to steer, direct, focus, reflect, or diffuse overlapping signals or beams having different polarizations for less divergence. The radome may be configured to be anisotropic by embedding fibers when calendering or mixing microspheres such that the fibers have a predetermined orientation (e.g., oriented vertically and/or oriented horizontally, etc.). By orienting the fibers in a predetermined orientation(s), the radome may be configured to be anisotropic and have property(ies) that differ in different directions.

In exemplary embodiments, a relatively thin flame retardant coating or layer may be applied to and/or integrated into at least a portion of the radome such that the radome has a UL94 flame rating. The flame retardant coating or layer may be sufficiently thin (e.g., a thickness within a range from about 0.002 microns to about 0.005 microns, etc.) so as to not completely occlude or block open cells of a core of the radome. In addition, exemplary embodiments, the radome is not sealed with a resin in order to also maintain an open cellular or porous structure for the radome. By maintaining the open cellular or porous structure for the radome, the relatively low dielectric constant of the radome may be maintained. The flame retardant may comprise a phosphorous-based flame retardant (e.g., ammonium phosphate salt, etc.) that is halogen free. By way of example, the flame retardant may include no more than a maximum of 900 parts per million chlorine, no more than a maximum of 900 parts per million bromine, and no more than a maximum of 1,500 parts per million total halogens.

Exemplary embodiments disclosed herein may include or provide one or more (but not necessarily any or all) of the following advantages or features, such as:
an overall low dielectric constant and an overall low loss tangent or dissipation factor (Df) at millimeter wave frequencies and/or at relatively high frequencies; and/or
a relatively strong core structure (e.g., polyolefin with microspheres (e.g., hollow glass microspheres, hollow plastic microspheres, hollow ceramic microspheres, microballoons, or bubbles, etc.), etc.) that minimizes or at least reduces electromagnetic energy loss; and/or
outer portions (e.g., outer surfaces, skins, etc.) that provide environmental protection and are capable of withstanding high impact; and/or
relatively low cost; and/or
allow for complexly shaped radomes to be made using a compression molding process; and/or
flame retardant (e.g., UL94 flammability certification of V0, etc.); and/or
suitable for outdoor use (e.g., UL756C F1 ultraviolet (UV) and water immersion certification, etc.); and/or
fitness for long-term ambient heat (e.g., UL 746B RTI certification, etc.).

In exemplary embodiments, a radome may be configured to provide outdoor environmental protection for 5G/mmWave antennas. In exemplary embodiments, a radome may be configured for use with indoor antennas, repeaters (e.g., indoor 5G repeaters, etc.), routers (e.g., 5G to WiFi6 indoor routers, etc.), devices that convert 5G signals to WiFi for in-building use, e.g., commercial building installations, etc. In exemplary embodiments, a radome may be configured for use as an in-building wireless radome, 5G small cell indoor radome, etc.

Exemplary embodiments disclosed herein may include or provide one or more (but not necessarily any or all) of the following usage benefits, such as very low signal loss for high frequencies, ultra low dielectric constant material, rigid, impact resistant, good tensile strength for structural requirements, and/or lightweight. Exemplary embodiments may accommodate for mmWave 5G frequencies (e.g., 28 GHz, 39 GHZ, etc.) and/or frequencies from about 20 GHz to about 90 GHz and/or from about 20 GHz to about 50 GHz and/or from about 18 GHz to about 40 GHz. Exemplary embodiments of the low dielectric constant radomes disclosed herein may allow power to be boosted (e.g., by about twenty-five percent or more, etc.) at 5G frequencies as compared to some conventional radomes, which power boost may be advantageous as 5G signals tend to have problems with penetration into buildings and homes.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific numerical dimensions and values, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (the disclosure of a first value and a second value for a given parameter may be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. For example, when permissive phrases, such as “may comprise”, “may include”, and the like, are used herein, at least one system comprises or includes the feature(s) in at least one exemplary embodiment. As used herein, the singular forms “a”, “an” and “the” may be intended to include the plural forms as well, unless the context clearly indicates otherwise. The terms “comprises,” “comprising,” “includes,” “including,” “has,” “have,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section could be termed a second element, component, region, layer or section without departing from the teachings of the example embodiments.

Spatially relative terms, such as “inner,” “outer,” “beneath”, “below”, “lower”, “above”, “upper”, “top”, “bottom”, and the like, may be used herein for ease of description to describe one element or feature's relationship to another element(s) or feature(s). Spatially relative terms may be intended to encompass different orientations of the device in use or operation. For example, if the device is turned over, elements described as “below” or “beneath” other elements or features would then be oriented “above” the other elements or features. Thus, the example term “below” may encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and may be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A material for a low dielectric, low loss radome, the material comprising a foamed thermoplastic having a dielectric constant less than 2.3 at frequencies up to 90 gigahertz and a plurality of closed pores including gas entrapped within at least some of the closed pores.

2. The material of claim 1, wherein the foamed thermoplastic includes nitrogen or carbon dioxide entrapped within at least some of the closed pores of the foamed thermoplastic.

3. The material of claim 1, wherein:
the gas entrapped within at least some of the closed pores of the foamed thermoplastic provides a weight reduction of the foamed thermoplastic within a range from about 10% to about 25%; and/or
the gas entrapped within at least some of the closed pores of the foamed thermoplastic provides a dielectric constant reduction of at least about 10%.

4. The material of claim 1, wherein:
the foamed thermoplastic has a lower dielectric constant due to the gas entrapped within at least some of the closed pores of the foamed thermoplastic;
the foamed thermoplastic has a pore density within a range from about 20% to about 50%; and
the foamed thermoplastic has a closed porosity.

5. The material of claim 1, wherein the foamed thermoplastic comprises a microcellular polymer foam.

6. The material of claim 1, wherein the foamed thermoplastic comprises polypropylene and/or polyolefin.

7. The material of claim 1, wherein the foamed thermoplastic comprises cyclic olefin copolymer.

8. The material of claim 1, wherein the foamed thermoplastic comprises a blend of polypropylene and cyclic olefin copolymer.

9. The material of claim 8, wherein the blend of the polypropylene and the cyclic olefin copolymer includes at least about 5 weight percentage to about 50 weight percentage of the cyclic olefin copolymer.

10. The material of claim 9, wherein the blend of the polypropylene and the cyclic olefin copolymer includes about 80 weight percentage of the polypropylene and about 20 weight percentage of the cyclic olefin copolymer.

11. The material of claim 8, wherein:
the blend of the polypropylene and the cyclic olefin copolymer has an average dielectric constant of about 2.2 for frequencies from 18 gigahertz to 40 gigahertz; and
the gas entrapped within at least some of the closed pores of the foamed thermoplastic reduces dielectric constant such that the foamed thermoplastic has an average dielectric constant less than 2 for frequencies from 18 gigahertz to 40 gigahertz.

12. The material of claim 1, wherein the foamed thermoplastic includes one or more open pores in addition to the plurality of closed pores having the gas entrapped within at least some of the closed pores of the foamed thermoplastic.

13. The material of claim 1, wherein the material includes fibers within the material that comprise polytetrafluoroethylene.

14. The material of claim 1, wherein the material includes one or more impact modifiers within the material that comprise one or more of acrylic styrene acrylonitrile, methacrylate butadiene styrene terpolymer, acrylate polymethacrylate copolymer, chlorinated polyethylene, ethylene vinyl acetate copolymer, acrylonitrile butadiene styrene terpolymer, and/or polyacrylate.

15. The material of claim 1, wherein:
the material has a dielectric constant less than 2.1 at frequencies up to 90 gigahertz; and
the material further comprises flame retardant within the material whereby the material has a UL94 flame rating of V0; and
the material is configured to have a loss tangent less than 0.01 for frequencies up to 90 gigahertz.

16. The material of claim 1, wherein:
the material is injection moldable; and/or
the material comprises thermoplastic injection moldable pellets.

17. A radome injection molded from the material of claim 1, wherein:
the radome has a dielectric constant less than 2.1 for frequencies up to 90 gigahertz;
the radome has a loss tangent less than 0.01 at frequencies up to 90 GHz; and
the radome has a UL94 flame rating of V0.

18. A method of making a low dielectric, low loss radome, the method comprising:
injecting a fluid into a thermoplastic to thereby provide a foamed thermoplastic having a dielectric constant less than 2.3 at frequencies up to 90 gigahertz; and
injection molding the foamed thermoplastic to thereby provide at least a portion of the radome that is injection molded from the foamed thermoplastic.

19. The method of claim 18, wherein injecting a fluid comprises injecting a supercritical fluid into the thermoplastic such that the injected supercritical fluid transitions to a gas phase, which gas is entrapped within at least some closed pores of the foamed thermoplastic.

20. The method of claim 18, wherein:
the fluid comprises nitrogen or carbon dioxide; and/or
the foamed thermoplastic comprises a blend of polypropylene and cyclic olefin copolymer; and/or
the foamed thermoplastic includes fibers within the foamed thermoplastic that comprise polytetrafluoroethylene.

21. A material for a low dielectric, low loss radome, the material comprising low dielectric constant, low loss filler within a resin matrix, the low dielectric constant, low loss filler reducing overall dielectric constant, wherein the resin matrix comprises cyclic olefin copolymer.

22. The material of claim 21, wherein:
the resin matrix comprises a blend of polypropylene and the cyclic olefin copolymer; and
low dielectric constant, low loss filler is within the blend of the polypropylene and the cyclic olefin copolymer.

23. The material of claim 22, wherein:
the blend of the polypropylene and the cyclic olefin copolymer includes about 80 weight percentage of the polypropylene and about 20 weight percentage of the cyclic olefin copolymer; and/or
the material has a dielectric constant of less than 2.1 for frequencies from 18 gigahertz to 40 gigahertz; and/or
the material includes fibers within the material that comprise polytetrafluoroethylene.

24. The material of claim 21, wherein:
the low dielectric constant, low loss filler comprises microspheres within the resin matrix; and/or
the resin matrix includes a plurality of closed pores, and the low dielectric constant, low loss filler comprises gas entrapped within at least some the closed pores of the resin matrix.

25. The material of claim 21, wherein the low dielectric constant, low loss filler comprises one or more of hollow glass microspheres, hollow plastic microspheres, hollow ceramic microspheres, microballoons, and/or bubbles within the resin matrix.
